(19) United States
(12) Patent Application Publication
(10) Pub. No.: US 2011/0110435 A1
(43) Pub. Date: May 12, 2011

(54) MULTI-STANDARD VIDEO DECODING SYSTEM

(75) Inventors: YI-SHIN LI, Tu-Cheng (TW); YI-SHIN TUNG, Tu-Cheng (TW); TSE-TSUNG SHIH, Tu-Cheng (TW); SHENG-WEI LIN, Tu-Cheng (TW)

(73) Assignee: HON HAI PRECISION INDUSTRY CO., LTD., Tu-Cheng (TW)

(21) Appl. No.: 12/625,765

(22) Filed: Nov. 25, 2009

(30) Foreign Application Priority Data
Nov. 9, 2009 (CN) 200910309464.X

(51) Int. Cl. H04N 7/26

(52) U.S. Cl. 375/240.25; 375/E07.026

(57) ABSTRACT

A multi-standard video decoding system comprises a memory, a multi-master bridge interface, a peer-to-peer bus, a plurality of processors and a plurality of hardware accelerators. The memory stores bit stream and temporal data produced during decoding flow. The multi-master bridge interface is connected to the memory. At least one of the plurality of processors receives bit streams from the memory via the multi-master bridge interface. Each of the plurality of hardware accelerators receives instructions from one of the plurality of the processors and operates related video decoding flow, and accesses the memory via the multi-master bridge interface. The peer-to-peer bus connects the plurality of processors and the plurality of hardware accelerators.

### BACKGROUND

1. Technical Field

The disclosure relates to a video decoding system, and more particularly to a multi-standard video decoding system.

2. Description of Related Art

To transmit multimedia data under bandwidth limitations, an encoded bit stream must be generated from the original file with the bit stream decoded upon receipt to recreate the content. Higher video quality, requires more complex decoding with higher computation capabilities.

Typically, real-time high definition video decoding is achieved by hardware implementation, but hardware solutions are generally limited to a single video encoding standard. Since more than one widely used video encoding standard exists, circuits in a hardware solution need to be compatible with different video encoding standards, thus affecting flexibility. Although software solutions are available for decoding multi-standard video encoding, such solutions are unable to consistently provide real-time high definition video decoding due to the sheer volume of data to be processed and exchanged.

### BRIEF DESCRIPTION OF THE DRAWINGS

FIG. 1 shows one embodiment of a video decoding system;

FIG. 2 is a block diagram of an embodiment of a video decoding system;

FIG. 3 illustrates one embodiment of a method for decoding a bit stream utilized by the video decoding system;

FIG. 4 illustrates one embodiment of a method for decoding a H.264 encoded bit stream utilized by the video decoding system;

FIG. 5 illustrates one embodiment of a method for decoding a VC-1 encoded bit stream utilized by the video decoding system.

### DETAILED DESCRIPTION

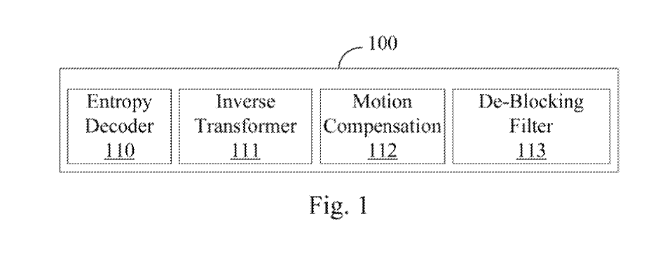

The disclosure utilizes a plurality of processors to balance heavy computation loading during video decoding and shifts common decoding functions from the plurality of processors to a plurality of hardware modules. With reference to FIG. 1, hardware modules 100 may comprise a plurality of hardware accelerators such as an entropy decoder 110, an inverse transformer 111, a motion compensation module 112 and a de-blocking filter 113. The hardware modules 110-113 may be utilized to reverse an entropy process and obtain variable length binary codes and motion vectors for reconstructing an image of a video, transform frequency coefficients of an image back to spatial data, reconstruct a current frame of a video from a previously reconstructed frame, and remove block effects in the image. Further details will be provided below.

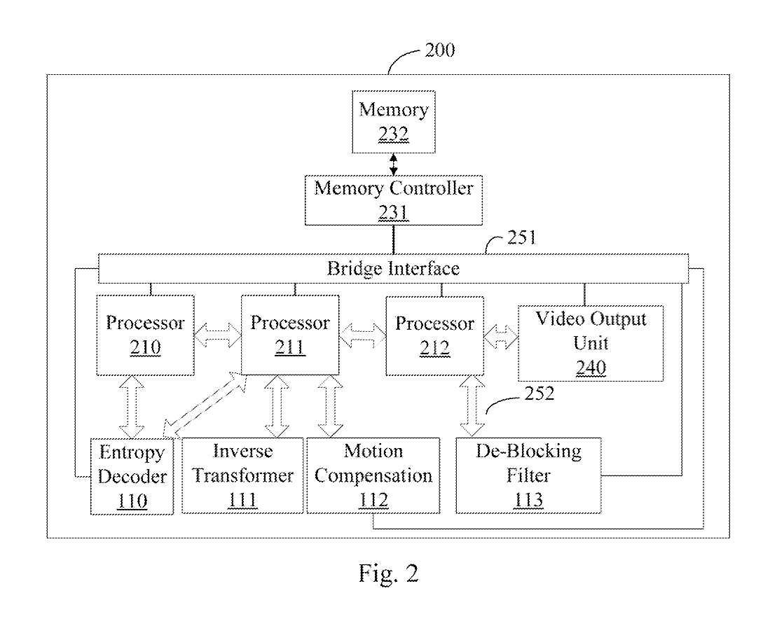

FIG. 2 is a block diagram of a video decoding system 200 as an embodiment of the hardware modules 100 shown in FIG. 1. The video decoding system 200 comprises a plurality of processors 210-212, a plurality of hardware accelerators such as the entropy decoder 110, the inverse transformer 111, the motion compensation module 112, the de-blocking filter 113, a memory controller 231, a memory 232, video output unit 240, a bridge interface 251 and peer-to-peer buses 2521-2528. The processors 210-212 may comprise any general purpose processor, such as a digital signal processor (DSP) or a reduced instruction set computing (RISC) processor. The video decoding system 200 utilizes peer-to-peer buses to connect the plurality of processors 210-212 and the plurality of hardware accelerators. Control and data communicating via peer-to-peer buses 2521-2528 do not need bus arbitration. The bridge interface 251 is a multi-master bridge interface. The plurality of processors 210-212 and the plurality of hardware accelerators directly access the memory 232 via the memory controller 231 and the bridge interface 251. The memory 232 may comprise random access memory (RAM), such as static or dynamic RAM, for storing coefficient data and pixel values generated during decoding. In one embodiment, each of the plurality of hardware accelerators may have designated buffers for storing temporal data. Alternatively, the plurality of hardware accelerators may have a share buffer for data exchange. A video output unit 240 converts image data decoded by the video decoding system 200 into a suitable format and outputs the converted image data as a video stream.

The video decoding system 200 may be implemented in various applications such as mobile devices, standard definition and high definition TVs, video conference devices, next-generation DVD players, set top boxes, for example. It should be understood that software decoding functions of the plurality of processors 210-212 and operations of the plurality of hardware accelerators may be changed depending on different video encoding standards. Software decoding functions of the processors 210-212 and operations of the hardware accelerators may be adjusted to balance system flexibility and efficiency. For example, software decoding functions of the processor 211 may perform inverse quantization and operations of the inverse transformer 111 may convert de-quantized coefficient data back to spatial data. Alternatively, operation of the inverse transformer 111 may perform inverse quantization and convert de-quantized coefficient data back to spatial data.

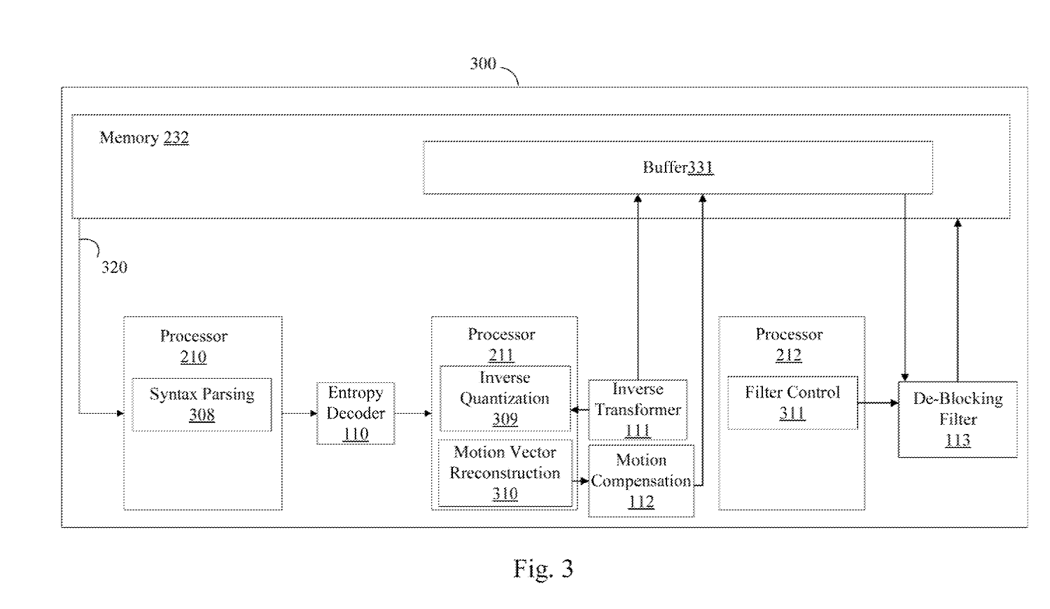

With reference to FIG. 3, one embodiment of a method for decoding an encoded bit stream utilized by the video decoding system 200 is depicted.

The processor 210 receives an encoded bit stream from the memory 232, and a syntax parsing process 308 of the processor 210 is operable to identify a video encoding standard used for encoding the bit stream. Upon identifying the video encoding standard, the syntax parsing process 308 directs data associated with the bit stream to the entropy decoder 110 and issues a decode instruction. The data input to the entropy decoder 110 may comprise the bit stream or macro blocks of the bit stream depending on the software functions of the syntax parsing process 308. If the syntax parsing process 308 completes decoding of the header information of the bit stream, macro blocks of the bit stream are input to the entropy decoder 110 as the input data thereof. In one embodiment, the processor 210 may determine whether to dynamically activate other processes upon identifying the video encoding standard. For example, the process 210 may determine to dynamically activate a motion vector reconstruction process in order to share computation loading with the processors 211, 212 in the subsequent decoding.

The entropy decoder 110 performs variable length decoding of the receives data and outputs data such as motion vectors, block quantization coefficients and quantized discrete cosine transformation(DCT) coefficient matrix. The output data is directed to the processor 211 for further decoding by the entropy decoder 110. The processor 211 receives the output data, directs block quantization parameters and quantized discrete cosine transformation coefficients matrix as input data to an inverse quantization process 309 and directs motion vectors as input data to a motion vector reconstruction process 310. The inverse quantization process 309 performs reverse quantization on the receives data to generate and transmit de-quantized coefficients to an inverse transformer 111, and issues a decode instruction to the inverse transformer 111. The motion vector reconstruction process 310 performs motion vector prediction and reconstruction on the receives data to generate and transmit predicted macro block to a motion compensation module 112, and issues a decode instruction to the motion compensation module 112. The inverse transformer 111 may utilize butterfly circuits to realize different inverse discrete cosine transformation (iDCT) of multiple video encoding standards. For example, the inverse transformer 111 may support inverse transformation such as 8×8 pixels iDCT of MPEG-2, 4×4 pixels reverse integer based transformation of H.264 bit streams and 8×8, 8×4, 4×8, 4×4 pixels reverse integer based transformation of WMV9/VC-1 bit streams, for example. The inverse transformer 111 performs iDCT computation, generates a set of residual values and stores the set in a buffer 331 of the memory 232. The buffer 331 is shared by the inverse transformer 111, the motion compensation module 112 and a de-blocking filter 113. Each of the plurality of hardware accelerators has access to buffer 331.

Once the motion compensation module 112 has received the predicted macro block and the decode instruction from the processor 211, the motion compensation module 112 fetches the set of residual values generated by the inverse transformer 111 from the buffer 331 and adds the set, with the predicted macro block, to obtain a reconstructed macro block. Once the reconstructed macro block is generated, the motion compensation module 112 stores the reconstructed macro block in the buffer 331 and the position of the current reconstructed frame in the memory 232. The de-blocking filter 113 performs de-blocking to reconstruct macro blocks in the current reconstructed frame. The de-blocking filter 113 is controlled by a filter control process 311 of the processor 212. The filter control process 311 monitors a status register of the motion compensation module 112. Once the motion compensation module 112 completes decoding, the filter control process 311 issues a decode instruction to the de-blocking filter 113 to fetch the reconstructed macro block from the buffer 331, perform de-blocking filtering and write the macro block back to the current reconstructed frame. The decoding of the macro block is complete.

Descriptions of exemplary embodiments of decoding H.264 and VC-1 encoded bit streams are described below.

H.264 standard, also known as MPEG-4 Part 10, was released by the ITU Telecommunication Standardization Sector (ITU-T) and MPEG group under International Organization for Standardization (ISO)/International Electrotechnical Commission (IEC) with an official name “Advanced Video Coding” (AVC). H.264 is a block based encoding standard. Unlike other encoding standards, H.264 extends motion estimation and motion compensation using variable block size as small as 4×4, providing finer granularity of motion area of frames.

H.264 allows motion prediction from multiple reference frames, or inter-frame prediction, the prediction is made based on no more than 31 past and 31 future reference frames. H.264 also provides intra-frame prediction without referring to any other frames. With regards to entropy coding schemes, H.264 recommends a single coding table for non-transform coefficients and context-adaptive coding technology for quantized transformation coefficients, which is proven to generate more efficient code representation and enhancing compression ratio. H.264 utilizes two context-adaptive coding technologies, context-adaptive variable codes (CAVLC) and context-based arithmetic coding (CABAC).

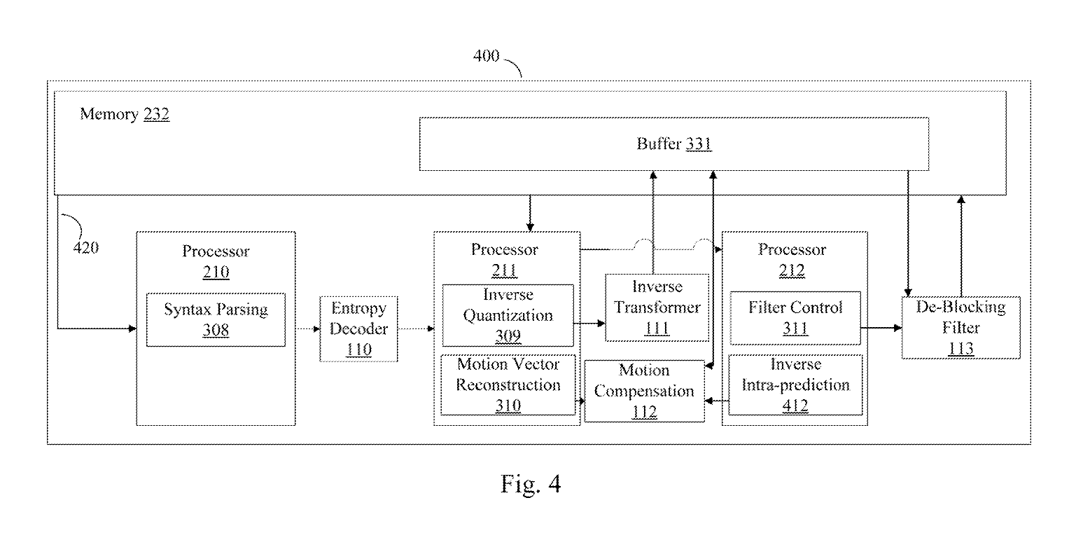

With reference to FIG. 4, one embodiment of a method for decoding H.264 bit stream utilized by the video decoding system 200 is depicted. The processor 210 receives a H.264 bit stream from the memory 232, and a syntax parsing process 308 of the processor 210 identifies a video encoding standard for the bit stream. Upon identification of the video encoding standard, the syntax parsing process 308 directs macro blocks of the H.264 bit stream to the entropy decoder 110 and issues a decode instruction. The entropy decoder 110 performs variable length decoding of the receives macro blocks and outputs data such as motion vectors, quantized coefficients and an intra-prediction mode indicator. The output data is directed to the processor 211 for further decoding by the entropy decoder 110. Once the processor 211 receives the quantized coefficients, it directs the quantized coefficients as input data to an inverse quantization process 309. The inverse quantization process 309 performs reverse quantization on the receives data and transmits de-quantized coefficients to the inverse transformer 111, and issues a decode instruction to the inverse transformer 111. The inverse transformer 111 performs 4×4 pixel reverse integer based transformation, generates a set of residual values and stores the set of residual values in a buffer 331 of the memory 232. Once the processor 211 receives the motion vectors, it directs the motion vectors as input data to a motion vector reconstruction process 310. The motion vector reconstruction process 310 fetches reference macro blocks from one or more previously reconstructed frames based on the receives motion vectors and generates an inter-predicted macro block. Once the inter-predicted macro block is generated, it is transmitted to a motion compensation module 112 by the processor 211.

The processor 211 also issues a decode instruction to the motion compensation module 112. Once the motion compensation module 112 receives the inter-predicted macro block and the decode instruction from the processor 211, the motion compensation module 112 fetches the set of residual values generated by the inverse transformer 111 from the buffer 331 and adds the set of residual values to obtain a reconstructed macro block Once the reconstructed macro block is generated, the motion compensation module 112 stores the reconstructed macro block in the buffer 331 and the position of the current reconstructed frame in the memory 232.

If the processor 211 receives the intra-prediction mode indicator, the processor 211 transmits the intra-prediction mode indicator to an inverse intra-prediction process 412 of the processor 212. The inverse intra-prediction process 412 reproduces an intra-prediction macro block. Once the intra-prediction macro block is generated, it is transmitted to the motion compensation module 112 by the processor 212. The processor 212 also issues a decode instruction to the motion compensation module 112. Once the motion compensation module 112 receives the intra-predicted macro block and the decode instruction from the processor 212, the motion compensation module 112 fetches the set of residual values generated by the inverse transformer 111 from the buffer 331 and adds the set of residual values with the intra-predicted macro block to obtain a reconstructed macro block. Once the reconstructed macro block is generated, the motion compensation module 112 stores the reconstructed macro block in the buffer 331 and the position of the current reconstructed frame in the memory 232.

The filter control process 311 of the processor 212 monitors a status register of the motion compensation module 112. Once the motion compensation module 112 completes decoding, the filter control process 311 issues a decode instruction to the de-blocking filter 113 to fetch the reconstructed macro block from the buffer 331, perform de-blocking filtering and write the reconstructed macro block back to the current reconstructed frame. The decoding of a macro block is finished.

VC-1 standard is based on WMV version 9. WMV (Windows Media Video), is a series video encoding format developed by Microsoft. Microsoft proposed WMV9 to Society of Motion Picture and Television Engineers (SMPTE) in 2003. SMPTE standardized WMV9 as VC-1 in 2004. As H.264, VC-1 utilizes redundancy part in the spatial domain and the time domain to achieve a highly efficient compression ratio.

VC-1 encoding, also based on block unit, differs from H.264 in providing seven block sizes for motion estimation and motion compensation, VC-1 provides four block sizes such as 16×16, 16×8, 8×16 and 8×8. VC-1 also provides inter-frame prediction and intra-frame prediction. For inter-frame prediction, VC-1 allows no more than one past and one future reference frames. For intra-frame prediction, unlike H.264's utilization of the pixel values of the spatial domain, VC-1 utilizes AC/DC prediction which uses quantized transformation coefficients of neighbor blocks as prediction data. A transform unit recommended by traditional standards is 8×8 block size or 4×4 block size, but VC-1 provides a technology called adaptive block size transform which allows four different block sizes. As well, VC-1 utilizes a method for de-blocking called overlap transform. Although traditional de-block filter methods can efficiently remove blocking effect, they are executed after reconstruction such that details of the image may be lost. Overlap transform technology of VC-1 provides pre-processing on I blocks in the spatial domain during encoding and post-processing during decoding. For entropy decoding, VC-1 utilizes variable length coding for non-transform coefficients and quantized transform coefficients.

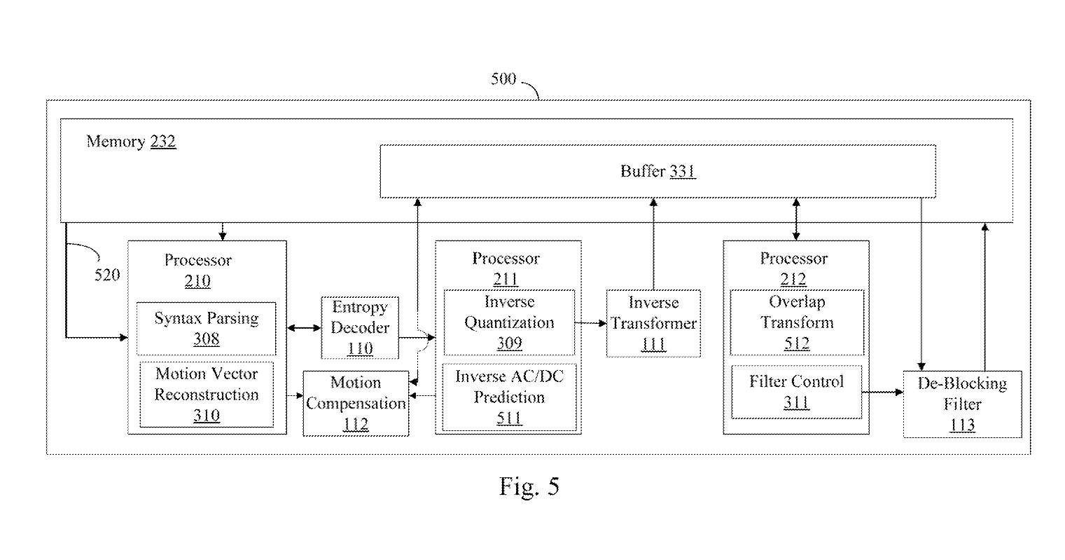

With reference to FIG. 5, one embodiment of a method for decoding VC-1 bit stream utilized by the video decoding system 200 is depicted. The processor 210 receives a VC-1 bit stream from the memory 232, and a syntax parsing process 308 of the processor 210 identifies a video encoding standard used for encoding the bit stream. Upon identifying the video encoding standard, the syntax parsing process 308 directs macro blocks of the VC-1 bit stream to the entropy decoder 110 and issues a decode instruction. The entropy decoder 110 performs variable length decoding of the receives macro blocks and outputs data such as motion vectors, quantized coefficients and an AC/DC prediction indicator. Once the output data is generated, motion vectors are transmitted back to the processor 210 and the other output data is transmitted to the processor 211 by the entropy decoder 110.

Once the processor 211 receives the quantized coefficients, it directs the quantized coefficients as input data to an inverse quantization process 309. The inverse quantization process 309 performs reverse quantization on the receives data and transmits de-quantized coefficients to an inverse transformer 111, and issues a decode instruction to the inverse transformer 111. The inverse transformer 111 performs reverse integer based transformation, generates a set of residual values and stores the set in a buffer 331 of the memory 232. Once the processor 210 receives the motion vectors, it directs the motion vectors as input data to a motion vector reconstruction process 310. The motion vector reconstruction process 310 fetches reference macro blocks from one previously reconstructed frame based on the received motion vectors and generates an inter-predicted macro block. Once the inter-predicted macro block is generated, it is transmitted to a motion compensation module 112 by the processor 210. The processor 210 also issues a decode instruction to the motion compensation module 112. Once the motion compensation module 112 receives the inter-predicted macro block and the decode instruction from the processor 210, the motion compensation module 112 fetches the set of residual values generated by the inverse transformer 111 from the buffer 331 and adds the set of residual values to obtain a reconstructed macro block. Once the reconstructed macro block is generated, the motion compensation module 112 stores the reconstructed macro block in the buffer 331 and the position of the current reconstructed frame in the memory 232.

If the processor 211 receives the AC/DC prediction indicator, the processor 211 transmits the AC/DC prediction indicator to an inverse AC/DC prediction process 511 of the processor 211. The inverse AC/DC prediction process 511 reproduces an intra-prediction macro block. Once the intra-prediction macro block is generated, it is transmitted to the motion compensation module 112 by the processor 211. The processor 211 also issues a decode instruction to the motion compensation module 112.

Once the motion compensation module 112 receives the intra-predicted macro block and the decode instruction, the motion compensation module 112 fetches the set of residual values generated by the inverse transformer 111 from the buffer 331 of the memory 232 and adds the set of residual values with the intra-predicted macro block to obtain a reconstructed macro block. Once the reconstructed macro block is generated, the motion compensation module 112 stores the reconstructed macro block in the buffer 331 and the position of the current reconstructed frame in the memory 232.

The processor 212 comprises two processes, one is an overlap transform process 512 and the other is a filter control process 311. The overlap transform process 311 monitors a status register of the inverse transformer 111. Once the inverse transformer 111 completes decoding, the overlap transform process 512 fetches the reconstructed macro block from the buffer 331, performs overlap transform on the reconstructed macro block and writes back to the buffer 331. The filter control process 311 of the processor 212 monitors a status register of the motion compensation module 112. Once the motion compensation module 112 completes decoding, the filter control process 311 issues a decode instruction to the de-blocking filter 113 to fetch the reconstructed macro block from the buffer 331, perform de-blocking filtering and write the reconstructed macro block back to the current reconstructed frame. The decoding of a macro block is finished.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

1. A multi-standard video decoding system, comprising:
a memory operable to store a plurality of bit streams and temporal data generated during video decoding;
a multi-master bridge interface adapted to connect to the memory;
a plurality of processors, at least one of which is operable to receive one of the plurality of bit streams from the memory via the multi-master bridge interface; and
a plurality of hardware accelerators, each of which is operable to receive a first decode instruction from one of the plurality of processors and access the memory via the multi-master bridge interface to perform video decoding in response to the first decode instruction.

2. The multi-standard video decoding system as claimed in claim 1, wherein the plurality of processors are interconnected through a peer-to-peer bus.

3. The multi-standard video decoding system as claimed in claim 1, wherein each of the plurality of processors connects to one of the plurality of hardware accelerators through a peer-to-peer bus.

4. The multi-standard video decoding system as claimed in claim 1, wherein the plurality of hardware accelerators comprises a first hardware accelerator to receive a second decode instruction from at least one of the plurality of processors and to perform variable length decoding in response to the second decode instruction.

5. The multi-standard video decoding system as claimed in claim 1, wherein the plurality of hardware accelerators comprises a second hardware accelerator to receive a third decode instruction from at least one of the plurality of processors and to perform inverse discrete cosine transformation in response to the third decode instruction.

6. The multi-standard video decoding system as claimed in claim 1, wherein the plurality of hardware accelerators comprises a third hardware accelerator to receive a fourth decode instruction from at least one of the plurality of processors and to perform motion compensation in response to the fourth decode instruction.

7. The multi-standard video decoding system as claimed in claim 1, wherein the plurality of hardware accelerators comprises a fourth hardware accelerator to receive a fifth decode instruction from at least one of the plurality of processors and to perform de-blocking filtering in response to the fifth decode instruction.

8. The multi-standard video decoding system as claimed in claim 1, wherein the plurality of hardware accelerators shares a buffer of the memory for data exchange.

9. A multi-standard video decoding system, comprising a memory, a multi-master bridge interface, a peer-to-peer bus, a plurality of processors, and a plurality of hardware accelerators, wherein:
at least one of the plurality of processors is operable to receive one of the plurality of bit streams from the memory via the multi-master bridge interface;
each of the plurality of hardware accelerators is operable to receive a first decode instruction from one of the plurality of processors, access the memory via the multi-master bridge interface and connect to each of the plurality of processors via the peer-to-peer bus.

10. The multi-standard video decoding system as claimed in claim 9, wherein the plurality of processors is interconnected through a peer-to-peer bus.

11. The multi-standard video decoding system as claimed in claim 9, wherein the plurality of hardware accelerators comprises a first hardware accelerator to receive a second decode instruction from at least one of the plurality of processors and to perform variable length decoding in response thereto.

12. The multi-standard video decoding system as claimed in claim 9, wherein the plurality of hardware accelerators comprises a second hardware accelerator to receive a third decode instruction from at least one of the plurality of processors and to perform inverse discrete cosine transformation in response thereto.

13. The multi-standard video decoding system as claimed in claim 9, wherein the plurality of hardware accelerators comprises a third hardware accelerator to receive a fourth decode instruction from at least one of the plurality of processors and to perform motion compensation in response thereto.

14. The multi-standard video decoding system as claimed in claim 9, wherein the plurality of hardware accelerators comprises a fourth hardware accelerator to receive a fifth decode instruction from at least one of the plurality of processors and to perform de-blocking filtering in response thereto.

15. The multi-standard video decoding system as claimed in claim 9, wherein the plurality of hardware accelerators shares a buffer of the memory for data exchange.
